(19) United States
(12) Patent Application Publication
(10) Pub. No.: US 2024/0336155 A1
(43) Pub. Date: Oct. 10, 2024

(54) CHARGING PILE

(71) Applicant: Luxshare Precision Industry Company Limited, SHENZHEN (CN)

(72) Inventor: GUANHSIUNG WANG, SHENZHEN (CN)

(73) Assignee: Luxshare Precision Industry Company Limited, SHENZHEN (CN)

(21) Appl. No.: 18/620,747

(22) Filed: Mar. 28, 2024

(30) Foreign Application Priority Data
Apr. 6, 2023 (CN) 202310384269.3

(51) Int. Cl. B60L 53/31; B60L 53/30; B60L 53/68

(52) U.S. Cl. CPC B60L 53/31; B60L 53/305; B60L 53/68; B60L 2250/16

(57) ABSTRACT

A charging pile, including a central control module as well as a 5G communication module, a wireless local area network module and a memory which are connected to the central control module. The central control module receives, by the 5G communication module, a unicast request signal transmitted by a source base station; has a memory space reserved in the memory according to the unicast request signal, and transmits a ready-to-receive signal to the source base station by the 5G communication module; receives, by the 5G communication module, to-be-transmitted user information sent by the source base station, and stores it in the memory space in the memory; and forwards the to-be-transmitted user information to a user terminal or other charging piles by the 5G communication module, or forwards the to-be-transmitted user information to other charging piles by the wireless local area network module.

### CLAIM OF PRIORITY AND CROSS-REFERENCE TO RELATED APPLICATION(S)

This application claims the benefit of Chinese Patent Application No. 202310384269.3, filed on Apr. 6, 2023, which is incorporated herein by reference in its entirety.

### BACKGROUND OF THE DISCLOSURE

### 1. Field of the Disclosure

The present disclosure relates to the technical field of charging devices, and particularly to a charging pile.

### 2. Description of the Related Art

A charging pile is an indispensable infrastructure for electric vehicles, with an increasing construction speed, which makes a distribution range and a distribution density of charging piles increased. However, the current charging pile only has a single function of charging the electric vehicles.

### BRIEF DESCRIPTION OF THE DISCLOSURE

In view of this, an objective of the present disclosure is to provide a charging pile, so as to add a 5G New Radio (5G NR) multi-hop relaying function.

The embodiments of the present disclosure provide a charging pile, including: a central control module; a 5G communication module connected to the central control module; a wireless local area network module connected to the central control module; and a memory connected to the central control module, where the central control module is configured to: receive, by the 5G communication module, a unicast request signal transmitted by a source base station; have a memory space reserved in the memory according to the unicast request signal, and transmit a ready-to-receive signal to the source base station by the 5G communication module; receive, by the 5G communication module, to-be-transmitted user information transmitted by the source base station, the to-be-transmitted user information being stored in the memory space in the memory; and forward the to-be-transmitted user information by the 5G communication module or the wireless local area network module.

Further, the central control module is further configured to: transmit an acknowledging signal to the source base station by the 5G communication module; and forward the to-be-transmitted user information in the memory space in the memory in response to acknowledging that the to-be-transmitted user information has been received.

Further, the central control module is further configured to: judge a connection status of the 5G communication module with other nearby charging piles; and make, in response to connection interruption of the 5G communication module, the 5G communication module in wireless communication connection to other charging piles by means of the wireless local area network module.

Further, the charging pile further includes: an environmental parameter sensing module, connected to the central control module to sense an environmental parameter.

Further, the charging pile further includes: a display module, connected to the central control module to display information.

Further, the charging pile further includes: an image monitoring module, connected to the central control module to monitor an image.

Further, the charging pile further includes: a power supply module, connected to the central control module to provide a charging service and supply power to the central control module, the 5G communication module, and the wireless local area network module.

Further, the power supply module further includes: a direct-current charging module, configured to output an adjustable direct current; and an alternating-current charging module, configured to output an alternating current.

Further, the charging pile further includes: a payment module, connected to the central control module to provide a charging payment function.

Further, the charging pile further includes: an emergency contact module, connected to the central control module to provide an emergency contact service.

The embodiments of the present disclosure provide a charging pile, including a central control module as well as a 5G communication module, a wireless local area network module and a memory which are connected to the central control module, where the central control module receives, by the 5G communication module, a unicast request signal transmitted by a source base station; has a memory space reserved in the memory according to the unicast request signal, and transmits a ready-to-receive signal to the source base station by the 5G communication module; receives, by the 5G communication module, to-be-transmitted user information sent by the source base station, and stores it in the memory space in the memory; and forwards the to-be-transmitted user information to a user terminal or other charging piles by the 5G communication module, or forwards the to-be-transmitted user information to other charging piles by the wireless local area network module. Thus, the charging pile may be used as a 5G NR multi-hop relay base station on the basis of an existing charging function, and may reduce a consumption of a network bandwidth and a power consumption of a transmitter base station.

### BRIEF DESCRIPTION OF THE DRAWINGS

The foregoing and other objectives, features and advantages of the present disclosure will become more apparent from the following description of embodiments of the present disclosure with reference to the accompanying drawings, in which:

FIG. 1 is a structural schematic diagram of a charging pile provided by an embodiment of the present disclosure;

FIG. 2 is a schematic diagram of function modules of a charging pile provided by an embodiment of the present disclosure;

FIG. 3 is a schematic diagram of a workflow of a central control module provided by an embodiment of the present disclosure;

FIG. 4 is a schematic diagram of another workflow of a central control module provided by an embodiment of the present disclosure; and

FIG. 5 is a schematic diagram of yet another workflow of a central control module provided by an embodiment of the present disclosure.

### DETAILED DESCRIPTION OF EMBODIMENTS OF THE DISCLOSURE

The present disclosure is described below based on embodiments, but the present disclosure is not only limited to these embodiments. In the following detailed description of the present disclosure, some specific details are described in detail. The present disclosure may be fully understood by those skilled in the art without the description of these detailed parts. In order to avoid confusing the substance of the present disclosure, well-known methods, processes, flows, elements and circuits are not described in detail.

In addition, it should be understood by those of ordinary skill in the art that the drawings provided herein are for illustrative purposes, and the drawings are not necessarily drawn to scale.

Meanwhile, it should be understood that in the following description, “circuit” refers to a conductive loop constituted by at least one element or sub-circuit through an electrical connection or an electromagnetic connection. When an element or a circuit is referred to as being “connected to” another element, or an element/a circuit is referred to as being “connected between” two nodes, it may be directly coupled or connected to the other element or intervening elements may be present. The connection between the elements can be physical, logical, or a combination thereof. On the contrary, when an element is referred to as being “directly coupled to” or “directly connected to” another element, it means that there is no intermediate element between the two elements.

Unless the context clearly requires otherwise, throughout the application document, the words “comprise”, “comprising”, and the like are to be construed in an inclusive sense as opposed to an exclusive or exhaustive sense; that is to say, in the sense of “including, but not limited to”.

In the description of the present disclosure, it should be understood that the terms “first”, “second” etc. are merely for descriptions and may not be understood as indication or implication of relative importance. In addition, in the description of the present disclosure, “a plurality” means two or more, unless otherwise specifically defined.

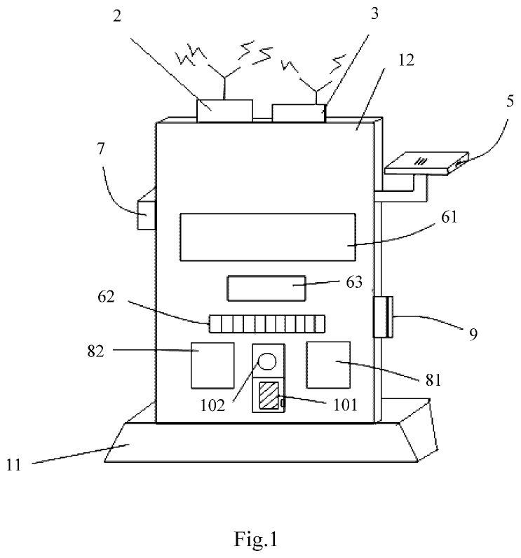

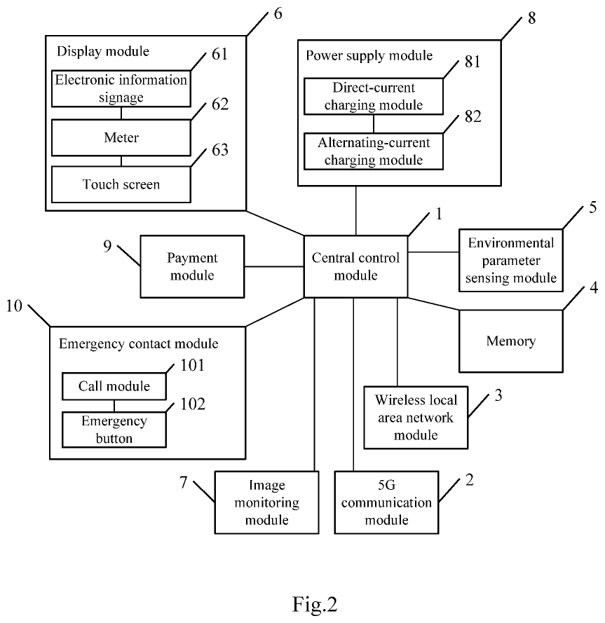

FIG. 1 is a structural schematic diagram of a charging pile provided by an embodiment of the present disclosure. As shown in FIG. 1, the charging pile includes a base 11 and a charging pile body 12. In one implementation, the base 11 is embedded into the ground, and the charging pile body 12 is mounted on the base 11. FIG. 2 is a schematic diagram of modules of a charging pile provided by an embodiment of the present disclosure. In combination with FIGS. 1-2, the charging pile further includes a central control module 1, a 5G communication module 2, a wireless local area network module 3 and a memory 4 which are integrated onto the charging pile body 12. It can be readily appreciated that the 5G communication module 2, the wireless local area network module 3 and the memory 4 are connected to the central control module 1 separately.

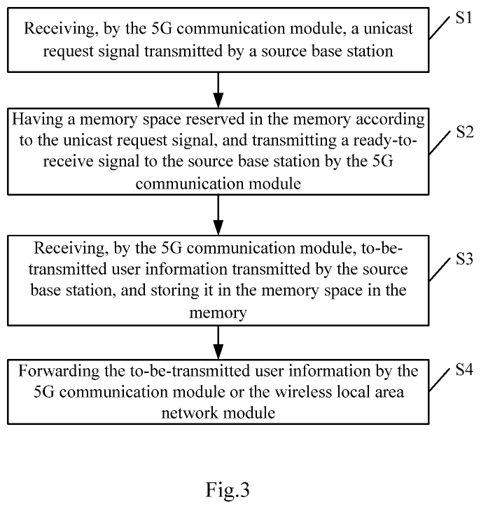

Further, FIG. 3 is a schematic diagram of a workflow of a central control module provided by an embodiment of the present disclosure. As shown in FIG. 3, the central control module 1 first receives, by the 5G communication module 2, a unicast request signal transmitted by a source base station (i.e. step S1); then has a memory space reserved in the memory 4 according to the unicast request signal, and transmits a ready-to-receive signal to the source base station by the 5G communication module 2 (i.e. step S2); then receives, by the 5G communication module 2, to-be-transmitted user information transmitted by the source base station, and stores it in the memory space in the memory 4 (i.e. step S3); and finally, forwards the to-be-transmitted user information by the 5G communication module 2 or the wireless local area network module 3 (i.e. step S4). Particularly, the to-be-transmitted user information may be forwarded by the 5G communication module 2 to other charging piles near the current charging pile or directly to a user terminal; or the to-be-transmitted user information may be forwarded by the wireless local area network module 3 to other charging piles. It is to be noted that the to-be-transmitted user information includes information that a source user needs to transmit to a terminal user. Thus, the 5G communication module 2 may serve as a WAN side of the charging pile, to achieve a function of a 5G micro base station; and the wireless local area network module 3 may further serve as an LAN side of the charging pile, to provide a high-quality wireless network service to a user of the charging pile or a 5G network. In one implementation, if the network quality of the wireless local area network module 3 is too poor or is disconnected by interference, the 5G communication module 2 may temporarily replace the wireless local area network module 3 to provide the wireless network service. Thus, the charging pile may provide the charging service to the user, and may further be used as a 5G NR multi-hop relay base station.

It is to be noted that in one implementation, the 5G communication module 2 is implemented based on the 5G NR technical standard. An operating frequency band may be based on 3.5 GHz bands of n77 and n78, supplemented by service frequency bands (such as n1 (2100 MHz), n3 (1800 MHZ), n28 (700 MHZ), and n41 (2500 MHZ)) provided by regional suppliers. In another aspect, the 5G NR radio access network (RAN) is dominated by Marco cells, in which small cells are additionally deployed to form a heterogeneous network. Full frequency reuse is used between small cells, and all the cells have a Backhaul (BH) capacity. The use of the multi-hop relay technology may improve a mobile broadband service, and reduce a consumption of a network bandwidth and a power consumption of a transmitter base station. Thus, the central control module 1 may be in communication connection to the source base station by means of the 5G communication module 2. In this implementation, the 5G communication module 2 and the wireless local area network module 3 are independent of each other. If the wireless local area network module 3 fails, the 5G communication module 2 may be used for an emergency contact and information transmission; or if the 5G communication module 2 is disconnected, the wireless local area network module 3 may be linked to other charging piles in a wireless local area network, to forward information from a source user to other charging piles.

It is to be further noted that in one implementation, the wireless local area network module 3 is a dual-band wireless local area network module (including ISM 2.4 GHz and ISM 5 GHz), and acts as a wireless access point in the charging pile. In this implementation, the central control module 1 continuously broadcasts a service set identifier (SSID) over a fixed period of time by means of the wireless local area network module 3, so that the user may use a mobile phone, a tablet, and other electronic devices to search for and connect a service set identifier, specified by the charging pile, in the wireless area network, and then may enjoy the network service provided by the charging pile. As an optional implementation, the wireless local area network module 3 uses three encryption methods (i.e. WEP, WPA3 and WPA-PSK/WPA2-PSK) to ensure the confidentiality of the network service for users.

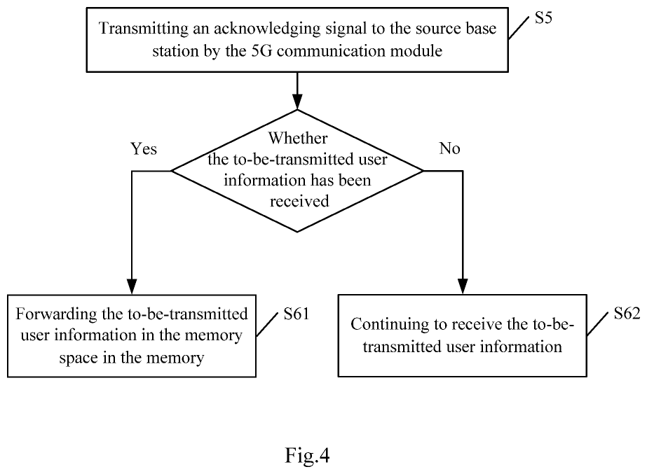

FIG. 4 is a schematic diagram of another workflow of a central control module provided by an embodiment of the present disclosure. As shown in FIG. 4, in one implementation, the central control module 1 is further configured to: transmit an acknowledging signal to the source base station by the 5G communication module 2 (i.e. step S5), so as to acknowledge whether the source base station has transmitted the to-be-transmitted user information. It can be readily appreciated that if the central control module 1 acknowledges that the to-be-transmitted user information has received, it may suspend the reception, and forward the to-be-transmitted user information in the memory space in the memory 4 (i.e. step S61), that is, stop communication connection to the source base station. Particularly, the to-be-transmitted user information may be forwarded by the 5G communication module 2 to other charging piles or directly to the user terminal; or the to-be-transmitted user information may be forwarded by the wireless local area network module 3 to other charging piles. Correspondingly, if the central control module 1 acknowledges that the to-be-transmitted user information has not been received completely, it may continue to receive the to-be-transmitted user information (i.e. step S62), that is, maintain communication connection to the source base station.

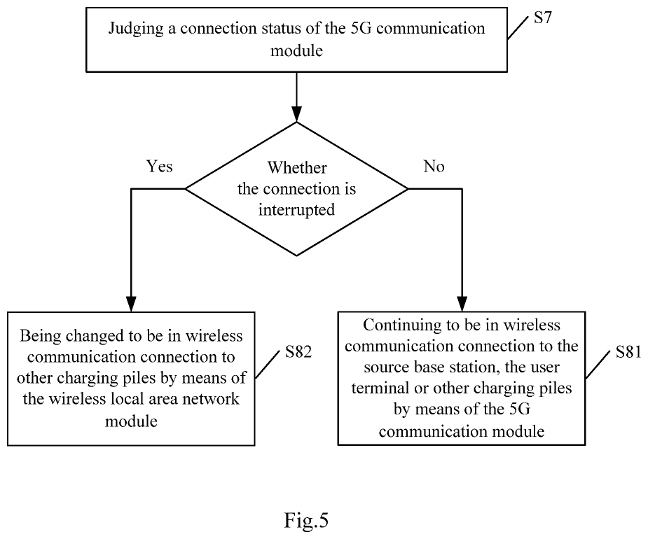

FIG. 5 is a schematic diagram of yet another workflow of a central control module provided by an embodiment of the present disclosure. As shown in FIG. 5, in one implementation, the central control module 1 is further configured to: judge a connection status of the 5G communication module 2 (i.e. step S7). Particularly, if connection between the 5G communication module 2 and the source base station, the user terminal or other charging piles near the current charging pile is uninterrupted, the central control module 1 may continue to be in wireless communication connection to the source base station, the user terminal or other charging piles by means of the 5G communication module 2 (i.e. step S81). In another aspect, if connection between the 5G communication module 2 and other nearby charging piles is interrupted, the central control module 1 may be changed to be in wireless communication connection to other charging piles by means of the wireless local area network module 3 (i.e. step S82), so as to ensure the function of the charging pile serving as the multi-hop relay base station.

In combination with FIGS. 1-2, in one implementation, the charging pile further includes an environmental parameter sensing module 5 which is connected to the central control module 1. It is to be noted that in this implementation, the environmental parameter sensing module 5 includes a temperature sensor, a humidity sensor, an air quality sensor and other sensors that may sense environmental parameters, thereby sensing a temperature, a humidity and the quality of air (for example, PM2.5, PM10, CO, ozone, etc.). Further, the central control module 1 may transmit relevant environmental parameters to a weather bureau or a supplier cloud server by means of the 5G communication module 2. Thus, based on a plurality of charging piles, it is helpful to achieve application of the Internet of Things (IoT) or the Artificial Intelligence Internet of Things (AIoT), for example, instant weather prediction, smart home, industrial automation, automatic driving of vehicles, etc.

In combination with FIGS. 1-2, in one implementation, the charging pile further includes a display module 6 which is connected to the central control module 1. It is to be noted that in this implementation, the display module 6 includes an electronic information signage 61, a meter 62 and a touch screen 63, where the electronic information signage 61 may be used for displaying information (such as advertising, news or membership information and a payment status of the user of the charging pile, etc.) received by means of the 5G communication module 2, or for displaying license plate information and other information, acquired in real time, of an electric vehicle of the user; the meter 62 may be used for displaying information about a charging capacity of the electric vehicle of the user, so as to provide a charging billing reference to the user; and the touch screen 63 may be used for displaying service options for the user to touch, or may be used for displaying metering and billing detailed information, membership information, the payment status, information relevant to the wireless area network service, environment sensing parameter information, information relevant to the 5G micro base station service, artificial Intelligence Internet of Things execution project information, etc. As an optional implementation, the charging pile may display all the information by means of only one display screen.

In combination with FIGS. 1-2, in one implementation, the charging pile further includes an image monitoring module 7 which is connected to the central control module 1. It is to be noted that in this implementation, the image monitoring module 7 may be used for identifying a license plate or the user, or may monitor a brightness and start an infrared LED to ensure an image monitoring function if the brightness is not enough. It is to be further noted that the image monitoring module 7 includes a static image acquisition apparatus or a dynamic video acquisition apparatus, which acquires picture or video information that is used for monitoring a situation around the charging pile and may be displayed by means of the display module 6.

In combination with FIGS. 1-2, in one implementation, the charging pile further includes a power supply module 8 which is connected to the central control module 1. It is to be noted that in this implementation, the power supply module 8 may provide the charging service to the user of the charging pile, and may further convert the mains electricity (or a power supply converted by solar energy and other energy sources) to a DC power supply, so as to supply power to the central control module 1, the 5G communication module 2, the wireless local area network module 3 and other modules in the charging pile.

In combination with FIGS. 1-2, in one implementation, the power supply module 8 includes a direct-current charging module 81 and an alternating-current charging module 82. It is to be noted that in this implementation, each of the direct-current charging module 81 and the alternating-current charging module 82 includes one charging gun and a charging line. Further, the direct-current charging module 81 may charge an on-board battery of the electric vehicle by outputting an adjustable direct current, so as to provide a fast charging service, or may charge batteries or independent storage batteries of other mechanical devices. In another aspect, the alternating-current charging module 82 may output an alternating current to an on-board charger of the electric vehicle. After the on-board charger performs direct-current voltage stabilization work such as alternating-current rectification, filtering, and voltage stabilization, the stabilized direct-current voltage is provided to the electric vehicle, thereby providing a slow charging service.

In combination with FIGS. 1-2, in one implementation, the charging pile further includes a payment module 9 which is connected to the central control module 1. It is to be noted that in this implementation, the payment module 9 includes a card swiping device, so that the user of the charging pile may swipe a card for payment according to the charging billing information displayed by the display module 6. As an optional implementation, the payment module 9 may provide a payment function to the user of the charging pile by means of code-scanning payment and other ways.

In combination with FIGS. 1-2, in one implementation, the charging pile further includes an emergency contact module 10 which is connected to the central control module 1. It is to be noted that in this implementation, the emergency contact module 10 includes a call module 101 and an emergency button 102, where the call module 101 may be used for a contact to staff, an emergency call, emergency broadcasting or the like. In another aspect, the emergency button 102 may allow the user to notify staff timely in case of a sudden situation or an emergency. Thus, the charging pile improves the safety by setting the emergency contact module 10.

The embodiments of the present disclosure provide a charging pile, including a central control module as well as a 5G communication module, a wireless local area network module and a memory which are connected to the central control module, where the central control module receives, by the 5G communication module, a unicast request signal transmitted by a source base station; has a memory space reserved in the memory according to the unicast request signal, and transmits a ready-to-receive signal to the source base station by the 5G communication module; receives, by the 5G communication module, to-be-transmitted user information sent by the source base station, and stores it in the memory space in the memory; and forwards the to-be-transmitted user information to a user terminal or other charging piles by the 5G communication module, or forwards the to-be-transmitted user information to other charging piles by the wireless local area network module. Thus, the charging pile may be used as a 5G NR multi-hop relay base station on the basis of an existing charging function, and may reduce a consumption of a network bandwidth and a power consumption of a transmitter base station.

The above descriptions are only preferred embodiments of the present disclosure, and are not intended to limit the present disclosure. For those skilled in the art, the present disclosure may have various modifications and changes. Any modification, equivalent replacement, improvement, and the like made within the spirit and principle of the present disclosure should fall within the protection scope of the present disclosure.

I/We claim:

1. A charging pile, comprising:
a central control module;
a 5G communication module, connected to the central control module;
a wireless local area network module, connected to the central control module; and
a memory, connected to the central control module;
wherein the central control module is configured to:
receive, by the 5G communication module, a unicast request signal transmitted by a source base station;
have a memory space reserved in the memory according to the unicast request signal, and transmit a ready-to-receive signal to the source base station by the 5G communication module;
receive, by the 5G communication module, to-be-transmitted user information transmitted by the source base station, the to-be-transmitted user information being stored in the memory space in the memory; and
forward the to-be-transmitted user information by the 5G communication module or the wireless local area network module.

2. The charging pile according to claim 1, wherein the central control module is further configured to:
transmit, by the 5G communication module, an acknowledging signal to the source base station; and
forward the to-be-transmitted user information in the memory space in the memory in response to acknowledging that the to-be-transmitted user information has been received.

3. The charging pile according to claim 1, wherein the central control module is further configured to:
judge a connection status of the 5G communication module with other nearby charging piles; and
make, in response to connection interruption of the 5G communication module, the 5G communication module in wireless communication connection to other charging piles by means of the wireless local area network module.

4. The charging pile according to claim 1, further comprising:
an environmental parameter sensing module, connected to the central control module to sense an environmental parameter.

5. The charging pile according to claim 1, further comprising:
a display module, connected to the central control module to display information.

6. The charging pile according to claim 1, further comprising:
an image monitoring module, connected to the central control module to monitor an image.

7. The charging pile according to claim 1, further comprising:
a power supply module, connected to the central control module to provide a charging service and supply power to the central control module, the 5G communication module, and the wireless local area network module.

8. The charging pile according to claim 7, wherein the power supply module comprises:
a direct-current charging module, configured to output an adjustable direct current; and
an alternating-current charging module, configured to output an alternating current.

9. The charging pile according to claim 1, further comprising:
a payment module, connected to the central control module to provide a charging payment function.

10. The charging pile according to claim 1, further comprising:
an emergency contact module, connected to the central control module to provide an emergency contact service.
